(19) United States
(12) Patent Application Publication
(10) Pub. No.: US 2003/0005802 A1
(43) Pub. Date: Jan. 9, 2003

(54) Die set with guide posts and guide bushes to be slidably fitted together

(76) Inventors: Tomio Kyono, Yokohama (JP); Yasuhiro Takahashi, Yokohama (JP); Masayuki Muguruma, Yokohama (JP)

Correspondence Address: McGLEW AND TUTTLE, P.C., SCARBOROUGH STATION, SCARBOROUGH, NY, 10510-0827, US

(21) Appl. No.: 10/177,801

(22) Filed: Jun. 20, 2002

(30) Foreign Application Priority Data
Jul. 3, 2001 (JP) 2001201561
Jan. 17, 2002 (JP) 2002-008700

(51) Int. Cl. B26D 5/08; B26F 1/14

(52) U.S. Cl. 83/531; 83/669; 83/684

(57) ABSTRACT

To provide a die set having rigid guide posts and rigid guide bushes which are fitted to each other. In the guide post and the guide bush having a sliding portion with a fitting clearance on the fitting surface thereof, even if an axis of the guide bush is tilted with respect to an axis of the guide post, the guide bush can be externally fitted onto the guide post easily. The guide post or the guide bush has a tip portion with a clearance slightly larger than the fitting clearance with respect to a mating element near the fitting tip end on the fitting surface, and a relief groove is provided around an entire circumference between a sliding portion having the fitting clearance and the tip portion. A distance from the tip portion to the sliding portion preferably has a predetermined or greater length.

### BACKGROUND OF THE INVENTION

1. Field of the Invention

The present invention relates to a die set for installing a die used for forming, blanking and the like to a forming machine and, more particularly, to constructions of a guide post and a guide bush capable of being fitted to a die set.

2. Description of the Related Art

For a die set, dies are installed between two plates called a punch holder and a die holder, and one die is mounted on one plate and the other die is mounted on the other plate. To open or close the die, the punch holder and the die holder are opened or closed. When the punch holder and the die holder are opened or closed, if the relative position thereof sifts longitudinally or transversely on a plane, the dies also shift. To prevent the positions of dies from shifting, a plurality of guide posts are erected on one plate, and guide bushes provided at corresponding positions of the other plate are externally fitted onto the guide posts so as to be slidable.

Since the guide bush is externally fitted onto the guide post so as to be slidable, the hole diameter of the guide bush is formed so as to be slightly larger than the outside diameter of the guide post. However, to prevent the position of die set from shifting, a difference in diameter between the die bush and the die post, that is, a clearance therebetween is formed so as to be very small. For example, if the guide post having a nominal diameter of 31.2 mm has an outside diameter of 31.2 mm+0/−0.002, the guide bush is formed so as to have a hole diameter of 31.2 mm+0.005/+0.008, the difference in diameter being 1/100 to 5/1000 mm.

When the guide bush is externally fitted onto the guide post, if the guide bush is tilted slightly, the bush cannot be fitted. FIG. 7 is a partially sectioned side view showing a state in which the guide bush is fitted onto the guide post. Correctly, after a guide bush 6 is positioned so as to face a guide post 5 as shown in FIG. 7A, the guide bush 6 is externally fitted onto the guide post 5 so that the axes thereof are aligned with each other as shown in FIG. 7B. However, if the axes thereof are tilted from each other slightly as shown in FIG. 7C, the tip end of the guide bush hole is caught by the outer periphery of the guide post, so that the guide bush cannot be fitted further. If an attempt is made to forcedly fit the guide bush, the tip end of the guide bush hole galls and sometimes damages the outer peripheral surface of guide post.

For a die set used for a particularly large die, the guide posts are provided at four corners of the die holder, and the guide bushes are provided at corresponding positions at four corners of the mating punch holder. When these two plates are combined together, the four guide posts must be fitted in the corresponding guide bushes at the same time. If one plate is tilted, though slightly, with respect to the mating plate, the die set cannot be assembled. For this reason, the assembling work of die set requires great skill.

A guide post and a guide bush having a construction for easy assembling has been proposed in, for example, Japanese Patent Laid-Open No. 58-58942. According to the laid-open patent, there is proposed a guide post in which a synthetic resin-made guide element formed into a spherical body with the same diameter as that of a guide post body is fixed to the tip end of the guide post so that the center of the guide element coincides with the axis of the guide post body.

It can be thought that since the tip portion of the guide post according to the proposal is spherical, the tip portion thereof can easily be inserted into the guide bush. However, even if the tip portion of the guide post is inserted into the guide bush, the spherical body is deformed because of being made of a synthetic resin and flexible, so that the guide post body is liable to be tilted when being inserted into the guide bush. Therefore, it is difficult to insert the guide post body, and a gall sometimes occurs between the guide post body and the guide bush.

Furthermore, the die and the guide post and the guide bush used for die set are usually made of a carbon tool steel and are quenched so as to have a hardness of HRC 50 or higher. If a synthetic resin-made sphere is used as in the above-described proposal, the sphere is damaged by the contact with the tip end of the hard guide bush, or wear occurs due to the contact with inside surface of bush, which may result in decreased durability and other drawbacks.

### SUMMARY OF THE INVENTION

The present invention has been achieved to eliminate the above drawbacks, and accordingly an object thereof is to provide a rigid guide post, a rigid guide bush, and a die set having these elements, in which even if the guide bush is tilted slightly with respect to the guide post, the tilt can be corrected, and the guide bush can be fitted easily along the outer periphery of the guide post.

A rigid guide post for slidably fitting into a rigid guide bush in accordance with the present invention includes:

a sliding portion having a sliding surface around the sliding portion and also having a fitting clearance between the sliding portion and the guide bush to be fitted;

a tip portion provided at an end of the guide post, having a clearance slightly larger than the fitting clearance with respect to the guide bush; and

a relief groove provided around the entire circumference of the guide post between the sliding portion and the tip portion.

A rigid guide bush for slidably fitting onto a rigid guide post in accordance with the present invention includes:

a sliding portion having a sliding surface on the inside of the sliding portion and also having a fitting clearance between the sliding portion and the guide post to be fitted;

a tip portion provided at an end of the guide bush, having a clearance slightly larger than the fitting clearance with respect to the guide post; and

a relief groove provided around the entire inside circumference of the guide bush between the sliding portion and the tip portion.

The distance from the tip portion to the sliding portion preferably have a predetermined or greater length or a length of 1/10 or more of the guide post diameter. However, if this distance is too long, the total length of guide post or guide bush having the relief portion increases, which makes the fitting of the guide post and the guide bush difficult. Therefore, the distance from the tip portion to the sliding portion should preferably be within the guide post diameter, more preferably ⅓ to 1/2 or less of the guide post diameter.

The maximum depth of the relief portion is preferably 1 to 20% of the guide post radius. Also, it is preferable that the diameter in the relief groove portion of the guide post gradually increase to the diameter of the sliding portion toward the sliding portion.

It is preferable that the tip portion be formed into a partial circle in a cross section including the axis, and the maximum outside diameter of the tip portion of the guide post or the minimum inside diameter of the tip portion of the guide bush have a clearance slightly larger than the fitting clearance with respect to the mating element. A too large clearance with respect to the mating element makes the fitting of the guide post and the guide bush difficult. Therefore, the clearance should preferably be 0.03 to 0.05 mm on one side.

The die set in accordance with the present invention has two plates, one plate (die holder) having a plurality of guide posts on the opposed surface thereof, and the other plate (punch holder) having a plurality of guide bushes capable of being externally fitted onto the guide posts on the opposed surface thereof.

In the die set, the guide post and the guide bush each has a sliding portion with a fitting clearance on the fitting surface. One of the guide post and the guide bush is provided with a tip portion, having a clearance slightly larger than the fitting clearance with respect to the mating element, near the fitting tip end, and a relief portion is provided around the entire inside or outside circumference of the guide bush or the guide post between the sliding portion having the fitting clearance and the tip portion.

The die set can also have features described above in relation to the guide post and the guide bush.

The guide post and the guide bush in accordance with the present invention can be applied to a guide post and a guide bush for stripper besides the die set.

### BRIEF DESCRIPTION OF THE DRAWINGS

FIG. 1 is a sectional view of a principal portion of a die set in accordance with the present invention;

FIG. 2 is a side view of a guide post in accordance with one embodiment of the present invention;

FIG. 3 is a partially sectioned side view for illustrating a state in which a guide bush is fitted onto the guide post shown in FIG. 2;

FIG. 4 is a side view of a guide post in accordance with another embodiment of the present invention;

FIG. 5 is a partially sectioned side view showing a guide post and a guide bush in accordance with still another embodiment of the present invention and a state in which the guide bush is fitted onto the guide post;

FIG. 6 is a partially sectioned side view for illustrating a rotation moment in the case where a guide bush is fitted onto a guide post; and

FIG. 7 is a partially sectioned side view for illustrating a state in which a guide bush is fitted onto a conventional guide post.

### DETAILED DESCRIPTION OF THE PREFERRED EMBODIMENTS

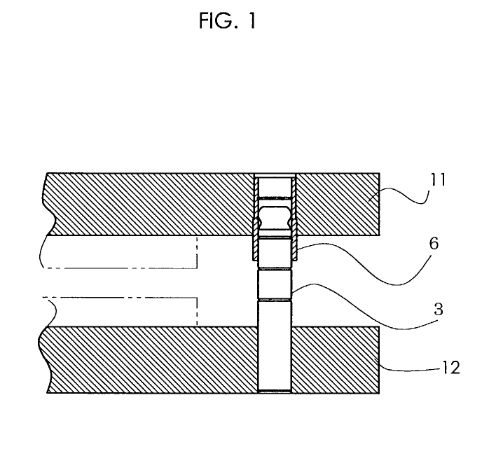

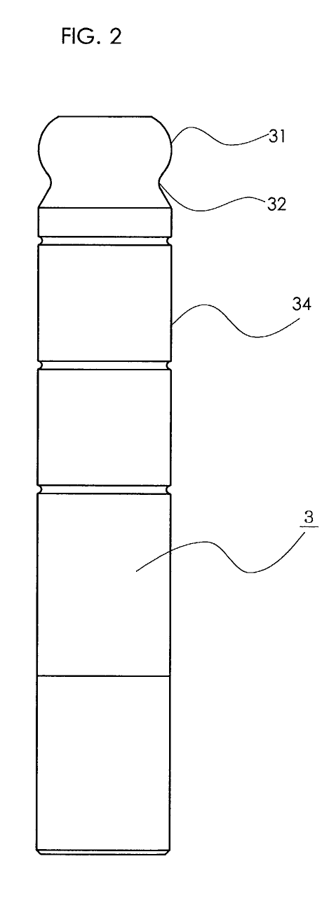

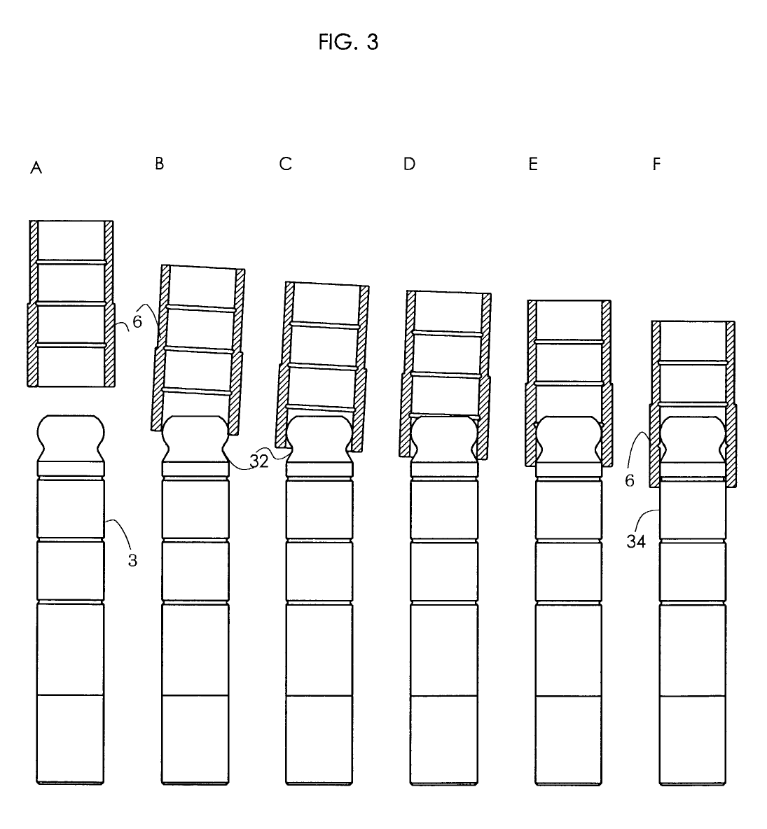

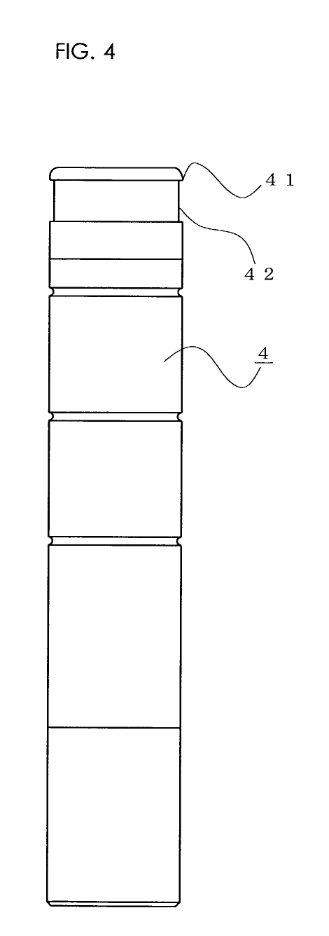

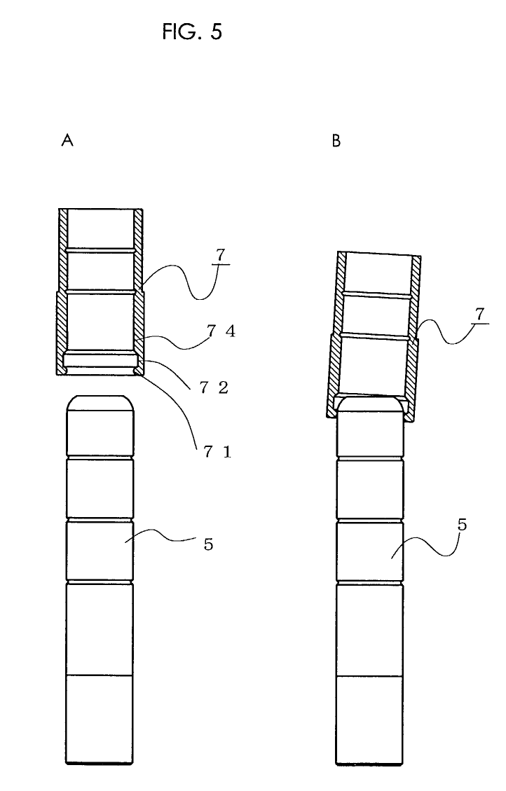

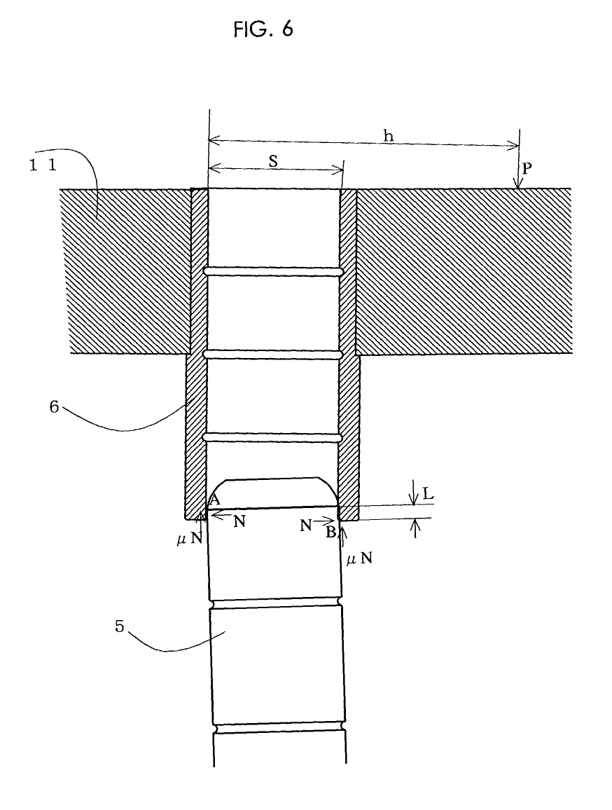

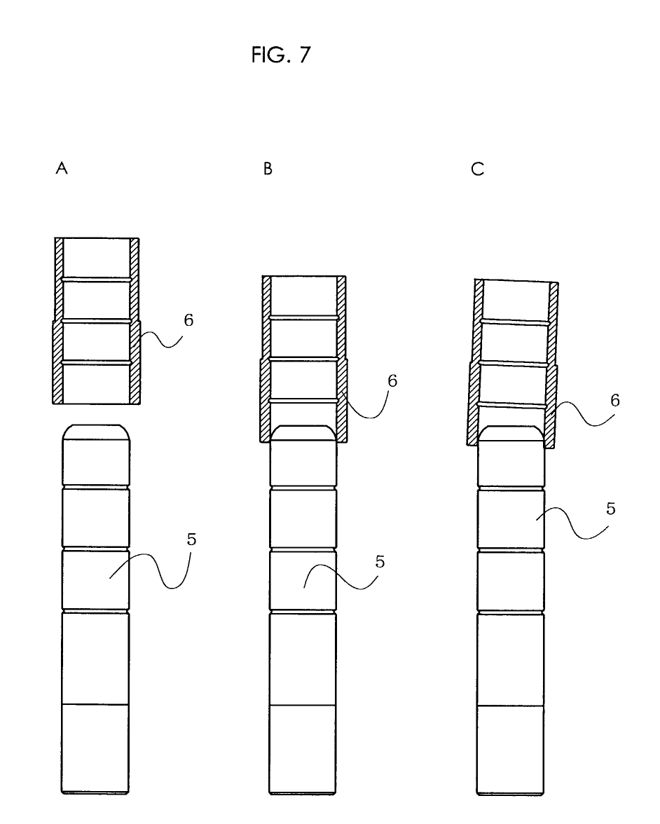

The present invention will now be described with reference to the accompanying drawings. FIG. 1 is a sectional view of a principal portion of a die set to which the present invention is applied. FIG. 2 is a side view of a guide post in accordance with one embodiment of the present invention, and FIG. 3 is a partially sectioned side view for illustrating a state in which a guide bush is fitted onto the guide post shown in FIG. 2. FIG. 4 is a side view of a guide post in accordance with another embodiment of the present invention, and FIG. 5 is a partially sectioned side view showing a guide post and a guide bush in accordance with still another embodiment of the present invention and a state in which the guide bush is fitted onto the guide post. FIG. 6 is a partially sectioned side view for illustrating a rotation moment in the case where a guide bush is fitted onto a guide post. FIG. 7 is a partially sectioned side view for illustrating a state in which a guide bush is fitted onto a conventional guide post.

Referring to FIG. 1, reference numerals 11 and 12 denote plates called a punch holder and a die holder, respectively, of a die set. A die used for forming etc. is installed between the punch holder 11 and the die holder 12. A fixed die is mounted on the opposed surface of the die holder (plate) 12, and a movable die is mounted on the opposed surface of the punch holder (plate) 11, so that the dies are opened and closed by reciprocating the punch holder 11 with respect to the die holder 12. In a hole formed in the die holder 12 of the die set, a rigid guide post 3 formed of a carbon tool steel is fixed so as to face upward. Also, in a hole formed in the punch holder 11, a rigid guide bush 6 formed of a carbon tool steel is fixed so that there is provided a clearance such that the guide bush 6 can be fitted along the outer periphery of the guide post 3. For example, in the case of a nominal diameter of 31.2 mm, the guide post has a diameter decreased by+0/-0.002 mm, and the bush hole has a diameter increased by+0.005/+0.008 mm, so that the guide bush can be fitted onto the guide post with a very small clearance provided.

As shown in FIG. 2, which is an enlarged side view of the guide post 3, a tip portion 31 of the guide post 3 has a clearance slightly larger than the fitting clearance, and a relief groove 32 is provided around the entire circumference just under the tip portion 31. The tip portion 31 is formed into a partial circle in a cross section including the axis, and the maximum outside diameter thereof has a clearance slightly larger than the fitting clearance with respect to the inside diameter of the guide bush 6, the clearance being preferably about 0.03 to 0.05 mm on one side. The relief groove 32 preferably has the maximum depth of 1 to 20% of the guide post radius. If the depth of the relief groove 32 is too shallow, when the guide bush 6 is tilted slightly, the tip end of the hole thereof comes into contact with the bottom of the relief groove 32, so that the depth must be about 1% of the radius to prevent the contact. If the depth of the relief groove 32 is too great, the strength of that portion is low, so that a too great depth is undesirable.

The guide post 3 has a large-diameter portion having the fitting clearance, that is, a sliding portion 34 under the relief groove 32, so that when the die set is driven, the guide bush 6 slides on this portion of the guide post 3. Since the sliding portion 34 is preferably as long as possible, the sliding portion starts from a position where the relief groove 32 ends. However, if the distance down to the end of the relief groove, that is, the distance from the tip end to the sliding portion has a predetermined or greater length, the guide bush 6 can be externally fitted onto the guide post 3 easily. The distance is preferably within the guide post diameter, and more preferably ⅓ to ½ or less of the guide post diameter. Also, if the diameter in the portion of the relief groove 32 of the guide post gradually increases toward the sliding portion 34, the guide bush 6 can be externally fitted conveniently.

A state in which the guide bush 6 is being fitted onto the guide post 3 will be explained with reference to FIG. 3. FIG. 3A shows a state in which the guide bush 6 faces the guide post 3, but it is not yet fitted onto the guide post 3. FIG. 3B shows a state in which when an attempt is made to externally fit the guide bush 6 onto the guide post 3, the guide bush 6 is slightly tilted with respect to the axis of the guide post 3. In the case where the axis of the guide bush 6 is tilted in this manner, the tip end of the guide bush hole is located in the relief groove 32 of the guide post 3. Therefore, as shown in FIG. 3C, the guide bush does not engage with the outer periphery of the guide post. When the guide bush is further pushed onto the guide post, the tip end of the guide bush hole runs onto the large-diameter portion of the guide post as shown in FIG. 3D, and thus the axis of the guide bush coincides with the axis of the guide post as shown in FIG. 3E. By pushing the guide bush further, the guide bush is externally fitted onto the sliding portion 34 with the diameter of guide post as shown in FIG. 3F.

Since the guide post 3 is provided with the relief groove 32 just under the tip portion 31 having a clearance slightly larger than the fitting clearance, the guide bush 6 can be externally fitted onto the guide post 3 easily.

FIG. 4 is a side view showing a construction of a guide post 4 in accordance with another embodiment. For this guide post 4 as well, a tip portion 41 has a diameter with a clearance slightly larger than the fitting clearance with respect to the guide bush hole, and a relief groove 42 at which the guide post has a smaller diameter is provided around the entire circumference just under the tip portion 41. The depth of the relief groove 42 is about 0.3 mm with respect to the outside diameter (about 31.2 mm) of the guide post, and the width thereof is 10 to 15 mm. In this case as well, the guide bush can be externally fitted onto the guide post easily.

FIG. 5A is a partially sectioned side view showing a guide post and a guide bush in accordance with still another embodiment, and FIG. 5B shows a state in which the guide bush is being fitted onto the guide post. In FIG. 5, a guide post 5 is the same as the guide post used generally. A guide bush 7 includes a tip portion 71 having a clearance slightly larger than the fitting clearance provided on the fitting face near the fitting tip end, a sliding portion 74 having the fitting clearance, and a relief groove 72 provided around the entire inside circumference between the tip portion 71 and the sliding portion 74. The tip portion 71 is formed into a partial circle in a cross section including the axis, and the maximum inside diameter thereof preferably has a clearance slightly larger than the clearance with respect to the guide post. This clearance may have a width of a degree such that the tip end of the guide post and the tip end of the guide bush can be fitted to each other. If the clearance is too wide, the fitting between the sliding surfaces of the guide post and the guide bush becomes difficult, so that the clearance between the guide post and the tip end of the guide bush should preferably be about 0.03 mm to 0.05 mm on one side.

The maximum depth of the relief groove 72 is preferably 1 to 20% of the guide post radius.

Also, the distance between the sliding portion 74 and the tip portion 71 preferably has a predetermined or greater length.

In this embodiment as well, the guide bush 7 can be fitted onto the guide post 5 easily.

The reason why the guide post and the guide bush in accordance with the present invention can easily be fitted to each other is thought to be as described below. The reason why rigid elements with a small clearance, such as the guide post and the guide bush, cannot be fitted easily is that as shown in FIG. 6, when the guide bush 6 installed in the plate is fitted onto the guide post 5, an offset load P is applied, and thereby the guide post 5 and the guide bush 6 are tilted. When the guide post 5 and the guide bush 6 are tilted and are brought into contact with each other at points A and B, in order to restore the guide bush 6 to the original position, the rotation moment around point A is counterclockwise, and must satisfy the following equation.

SμN+LN>hP

where, S is an inside diameter of guide bush (coincides substantially with an outside diameter of guide post), μ is the coefficient of friction, N is a force acting perpendicularly at contact points A and B, L is the distance between points A and B, and h is the distance to a position where the offset load acts.

Since P equals 2 μN because of the vertical force balance, the above-described equation is expressed as

SμN+LN>2μNh

From this equation, L>μ(2h−S) is derived.

Since the point B is located substantially at the tip end of the guide bush, it can be said that in the state in which the guide post 5 is inserted into the guide bush 6, the insertion depth of the tip end of guide post is L. If the insertion depth takes a value expressed by the above-described equation or a higher value, the rotation moment around the point A is counterclockwise, so that the guide post can be inserted into the guide bush smoothly. Specifically, this fact means that if the guide post and the guide bush can be fitted to the depth expressed by the above-described equation in parallel with the axes thereof being aligned, the guide post and the guide bush can be fitted to each other easily after then. In the above-described equation, although the distance h to a position where the offset load acts is unfixed, the coefficient of friction μ is very low. The experiment conducted by the inventors has revealed that if the guide post and the guide bush are fitted to each other to a depth of 1/10 or more of the guide post diameter, further fitting operation can be performed easily.

According to the present invention, the tip portion having a clearance slightly larger than the fitting clearance is provided near the tip end of the guide post or the guide bush, by which the tip portion thereof can be fitted easily, and also the sliding portion is provided at a distance having a predetermined or greater length from the tip end. Therefore, in the case where the relief groove is provided on the guide post, referring to FIG. 6, the points A and B correspond to the tip end of the guide post and the sliding portion of the guide post, respectively. Therefore, the insertion depth is greater than the value required in the above-described equation, so that it can be thought that the fitting operation can be performed easily without galling.

In the above description, explanation has been given so that the tip portion of the guide post or the guide bush is formed into a partial circle in a cross section including the axis thereof. However, even a slight flat portion has only to have a degree of freedom such that the tip portion of the guide post is inserted into the guide bush, the tip portions of these elements being fitted to each other, and the sliding portions thereof can be fitted to each other.

In the above description, the guide post and the guide bush in accordance with the present invention have been explained in relation to the die set. The guide post and the guide bush in accordance with the present invention can be used to keep a position between a die used in combination with a die set, especially a die which is installed to the die set and moves together with the die set, and a stripper which moves with respect to the die. The guide post and the guide bush used between the stripper and the die are essentially the same as those used in the die set, so that the explanation thereof is omitted.

As described above in detail, for the guide post having the relief groove just under the tip portion or the guide bush as in the present invention, the guide bush can be externally fitted onto the guide post easily, so that the die set or the die can be combined easily.

What is claimed is:

1. A rigid guide post for slidably fitting into a rigid guide bush, comprising
a sliding portion having a fitting surface surrounding the sliding portion with a fitting clearance with a guide bush to be fitted,
a tip portion, at an end of the guide post, having a clearance with the guide bush, the clearance of the tip portion being a little bigger than the fitting clearance
and
a relief groove surrounding all the guide post between the sliding portion and the tip portion.

2. A rigid guide post as set forth in claim 1, wherein a distance from the tip portion to the sliding portion is longer than a certain length.

3. A rigid guide post as set forth in claim 2, wherein the maximum depth of the relief groove is 1% to 20% of a radius of the sliding portion and the distance from the tip portion to the sliding portion is less than a diameter of the sliding portion.

4. A rigid guide post as set forth in claim 3, wherein a diameter, at the relief groove, of a cross section of the guide post gradually reaches the diameter of the sliding portion, as approaching the sliding portion.

5. A rigid guide bush for slidably fitting on a rigid guide post, comprising
a sliding portion having a fitting surface on an inside surface of the sliding portion with a fitting clearance with a guide post to fit,
a tip portion, at an end of the guide bush, having a clearance with the guide post, the clearance of the tip portion being a little bigger than the fitting clearance
and
a relief groove surrounding the inside surface of the guide bush between the sliding portion and the tip portion.

6. A rigid guide bush as set forth in claim 5, wherein a distance from the tip portion to the sliding portion is longer than a certain length.

7. A rigid guide bush as set forth in claim 6, wherein the maximum depth of the relief groove is 1% to 20% of a radius of the sliding portion and the distance from the tip portion to the sliding portion is less than a diameter of the sliding portion.

8. A rigid guide bush as set forth in claim 7, wherein a diameter, at the relief groove, of a cross section of the guide bush gradually reaches the diameter of the sliding portion, as approaching the sliding portion.

9. A die set having two plates of which one has a plurality of rigid guide bushes on a face of the plate facing the other while the other has, on a face of the other plate facing the one, a plurality of rigid guide posts which can slidably fit into each of the guide bushes, the guide bushes and the guide posts each comprising a sliding surface on a sliding portion, the sliding portion of each of the guide posts having a fitting clearance with each of the guide bushes,
the guide bushes and the guide posts each comprising
a tip portion, at an end of the guide bushes or the guide posts, having a clearance with the guide post or the guide bush which clearance of the tip portion is a little bigger than the fitting clearance;
and
a relief groove surrounding an inside surface of the guide bush or an outside surface of the guide post between the sliding portion and the tip portion.

10. A die set as set forth in claim 9, wherein a distance from the tip portion to the sliding portion of the guide post or the guide bush having the tip portion is longer than a certain length.

11. A die set as set forth in claim 10, wherein the maximum depth of the relief groove is 1% to 20% of a radius of the sliding portion of the guide post or the guide bush having the relief groove and the distance from the tip portion to the sliding portion is less than a diameter of the sliding portion.

12. A die set as set forth in claim 11, wherein a diameter, at the relief groove, of a cross section of the guide post or the guide bush having the relief groove gradually reaches the diameter of the sliding portion of the guide post or the guide bush having the relief groove, as approaching the sliding portion.
